(19) United States
(12) Patent Application Publication
(10) Pub. No.: US 2026/0178648 A1
(43) Pub. Date: Jun. 25, 2026

(54) QUERY DIRECTION METHOD AND APPARATUS

(71) Applicant: Kraft Foods Group Brands LLC, Chicago, IL (US)

(72) Inventors: Lei Fang, Glenview, IL (US); Eryn Ashley MacKenzie, Chicago, IL (US); Samrendra K. Singh, Bolingbrook, IL (US); Ryan Wolbeck, Jordan, MN (US)

(21) Appl. No.: 19/414,636

(22) Filed: Dec. 10, 2025

Related U.S. Application Data
(60) Provisional application No. 63/738,589, filed on Dec. 24, 2024.

(51) Int. Cl. G06F 16/353; G06F 16/34; G06F 40/253

(52) U.S. Cl. CPC G06F 16/353; G06F 16/345; G06F 40/253

(57) ABSTRACT

A control circuit receives a user query and inputs that query to at least one model-based query classifier and outputs a selection one or more information resources to provide a selected information resource. The control circuit can be further configured to assess the aforementioned user query to determine context sufficiency (for example, by employing predetermined large language model prompts to determine the context sufficiency). When the context sufficiency is determined to be sufficient, the control circuit can provide the user query as an output query and direct the output query to the selected information resource. When, however, the context sufficiency is determined to be insufficient, the control circuit can rephrase the user query to include additional chat history to serve as the output query and then direct that output query to a selected information resource corresponding to a nearest prior query on a same query sequence.

### CROSS-REFERENCE TO RELATED APPLICATION

This application claims the benefit of U.S. Provisional Application No. 63/738,589 filed Dec. 24, 2024, which is incorporated herein by reference in its entirety.

### TECHNICAL FIELD

These teachings relate generally to information system query intake and direction.

### BACKGROUND

Many application settings include the opportunity to access multiple different information repository systems. In such a case, and particularly where both legacy systems and newer systems are included, it can become technically challenging and frustrating for a user to gain the content they seek as such systems can require very different technical particulars to properly access their content. In particular, such users may not know what systems are available, how a query for a particular system should be expressed, the taxonomy that corresponds to the content for a given system, and so forth. Even a well-trained user can be foiled as systems are added, updated, deleted, or other changes are made with respect to any such system.

### BRIEF DESCRIPTION OF DRAWINGS

Various needs are at least partially met through provision of the query direction method and apparatus described in the following detailed description, particularly when studied in conjunction with the drawings, wherein:

FIG. 1 comprises a block diagram as configured in accordance with various embodiments of these teachings;

FIG. 2 comprises a flow diagram as configured in accordance with various embodiments of these teachings;

FIG. 3 comprises a flow diagram as configured in accordance with various embodiments of these teachings;

FIG. 4 comprises a flow diagram as configured in accordance with various embodiments of these teachings;

FIG. 5 comprises a flow diagram as configured in accordance with various embodiments of these teachings;

FIG. 6 comprises a schematic flow representation as configured in accordance with various embodiments of these teachings;

FIG. 7 comprises a schematic flow representation as configured in accordance with various embodiments of the invention; and

FIG. 8 comprises a schematic flow representation as configured in accordance with various embodiments of these teachings.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present teachings. Also, common but well-understood elements that are useful or necessary in a commercially feasible embodiment are often not depicted in order to facilitate a less obstructed view of these various embodiments of the present teachings. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein. The word “or” when used herein shall be interpreted as having a disjunctive construction rather than a conjunctive construction unless otherwise specifically indicated.

### DETAILED DESCRIPTION

Generally speaking, these various embodiments can provide for processing and directing a query to an information resource selected from amongst a plurality of information resources. By one approach, a control circuit receives a user query and inputs that query to at least one model-based query classifier and outputs a selection of at least one of the plurality of information resources to provide a selected information resource. The control circuit can be further configured to assess the aforementioned user query to determine context sufficiency (for example, by employing predetermined large language model prompts to determine the context sufficiency). When the context sufficiency is determined to be sufficient, the control circuit can provide the user query as an output query and direct the output query to the selected information resource. When, however, the context sufficiency is determined to be insufficient, the control circuit can rephrase the user query to include additional chat history to serve as the output query and then direct that output query to a selected information resource corresponding to a nearest prior query on a same query sequence.

By one approach, the aforementioned at least one model-based query classifier can comprise one or both of a large language model-based binary classifier and an autonomous agent hybrid with a plurality of differing independent large language model chains.

By one approach, the aforementioned inputting of the user query to at least one model-based query classifier and outputting a selection of at least one of the plurality of information resources to provide a selected information resource can further comprise selecting the at least one of the plurality of information resources as a further function of a plurality of binary classifiers.

By one approach, the aforementioned directing of an output query to a selected information resource can further comprise directing that output query to a selected information resource as a function of a memory gate and the query sequence to facilitate a successful query rephrasing process. The control circuit, by one approach, can be configured to use that memory gate to prevent mistakenly using memory when a user switches topics while nevertheless staying in a same information resource.

By one approach, these teachings can comprise a computer program (or programs) that itself comprises instructions that, when the computer program is executed by a computer, causes the computer to carry out any of the foregoing or below-described steps, actions, and/or functions.

So configured, these teachings have exhibited a strong capability to accurately classify user questions to different application programming interfaces in complex conversational environments. As a result, even relatively untrained users can access and make use of data that is otherwise stored in various incompatible ways and that is accessed via various incompatible approaches without other human oversight and essentially in real time.

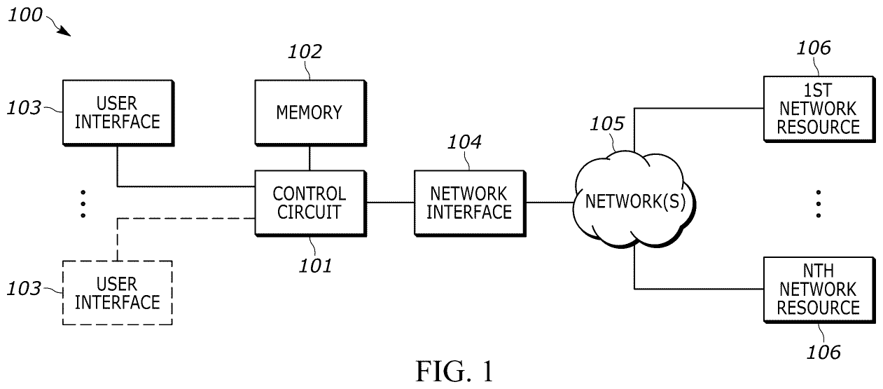

These and other benefits may become clearer upon making a thorough review and study of the following detailed description. Referring now to the drawings, and in particular to FIG. 1, an illustrative apparatus 100 that is compatible with many of these teachings will first be presented.

In this particular example, the enabling apparatus 100 includes a control circuit 101. Being a “circuit,” the control circuit 101 therefore comprises structure that includes at least one (and typically many) electrically-conductive paths (such as paths comprised of a conductive metal such as copper or silver) that convey electricity in an ordered manner, which path(s) will also typically include corresponding electrical components (both passive (such as resistors and capacitors) and active (such as any of a variety of semiconductor-based devices) as appropriate) to permit the circuit to effect the control aspect of these teachings.

Such a control circuit 101 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. This control circuit 101 is configured (for example, by using corresponding programming as will be well understood by those skilled in the art) to carry out one or more of the steps, actions, and/or functions described herein.

It will be appreciated that the control circuit 101 may comprise a single integrated platform or may comprise a plurality of such circuits that work in cooperation with one another.

The control circuit 101 operably couples to a memory 102. This memory 102 may be integral to the control circuit 101 or can be physically discrete (in whole or in part) from the control circuit 101 as desired. This memory 102 can also be local with respect to the control circuit 101 (where, for example, both share a common circuit board, chassis, power supply, and/or housing) or can be partially or wholly remote with respect to the control circuit 101 (where, for example, the memory 102 is physically located in another facility, metropolitan area, or even country as compared to the control circuit 101). As with the control circuit 101, the memory 102 may comprise a singular structure or may comprise a plurality of memory platforms that collectively comprise the “memory” of this apparatus 100.

In addition to other information that is described herein, this memory 102 can serve, for example, to non-transitorily store the computer instructions that, when executed by the control circuit 101, cause the control circuit 101 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as a dynamic random access memory (DRAM).)

The control circuit 101 also operably couples to one or more user interfaces 103. This user interface 103 can comprise any of a variety of user-input mechanisms (such as, but not limited to, keyboards and keypads, cursor-control devices, touch-sensitive displays, speech-recognition interfaces, gesture-recognition interfaces, and so forth) and/or user-output mechanisms (such as, but not limited to, visual displays, audio transducers, printers, and so forth) to facilitate receiving information and/or instructions from a user and/or providing information to a user.

In this example, the control circuit 101 also operably couples to a network interface 104. So configured the control circuit 101 can communicate with other network elements 106 (both within the apparatus 100 and external thereto) via the network interface 105 and one or more intervening networks.

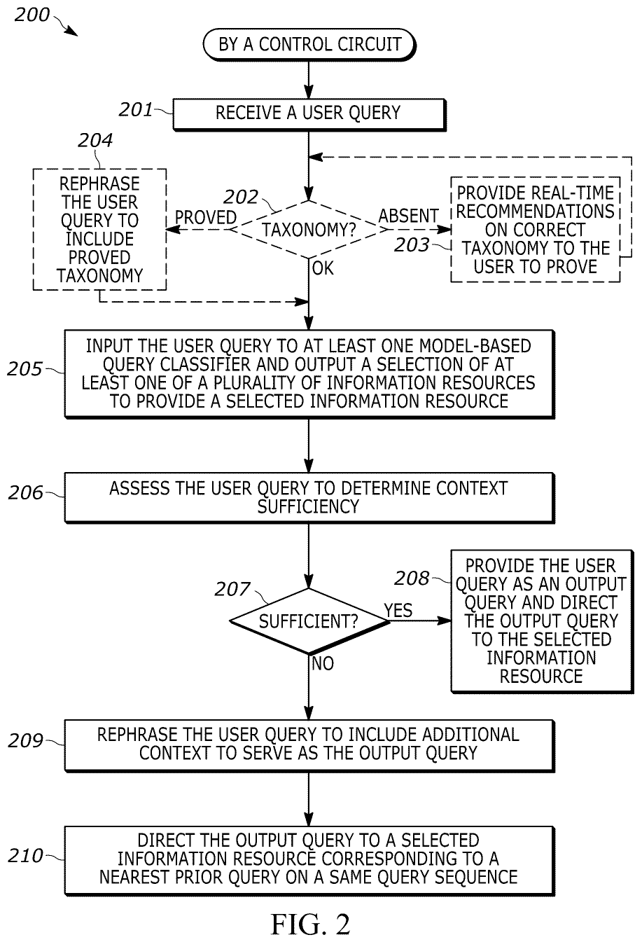

Referring now to FIG. 2, a process 200 that can be carried out, for example, in conjunction with the above-described application setting (and more particularly via the aforementioned control circuit 101) will be described. Generally speaking, this process 200 serves to facilitate processing and directing a query to an information resource selected from amongst a plurality of information resources.

At block 201, the control circuit 101 receives a user query (via, for example, the aforementioned user interface 103). That query may be directly received via, for example, a keyboard that is directly coupled to the control circuit 101. That query may also be received in other ways, however, including by text or in-app messaging, emailing, and so forth.

That query can comprise text that may (but likely is not) properly formatted or using an appropriate syntax to compatibly access an information store that contains an appropriate response to that query. That query may even be lacking, or misleading, with respect to its substantive content. The latter can occur when the user lacks understanding about such things as a taxonomy that a given enterprise or information source may observe.

At optional block 202, the control circuit 101 can assess the aforementioned user query to conduct a taxonomy check. (Although presented in FIG. 2 at the beginning of the process 200, it will be understood that this taxonomy check can occur elsewhere. For example, a taxonomy check can be beneficial to ensure that the taxonomy employed in the query is consistent with the taxonomy of a particular information resource. Accordingly, conducting a taxonomy check may be delayed until one or more particular information resources are selected in order to ensure compatibility in these regards.) For example, in one application setting, this can comprise checking for taxonomy absence for product/category related query contents. When taxonomy absence is detected, at block 203 the control circuit 101 can provide real-time recommendations on correct taxonomy to the user (via, for example, the aforementioned user interface 103) to select from amongst and/or to approve. When taxonomy is approved, at block 204 the control circuit 101 can rephrase the user query to include approved taxonomy.

At block 205, the control circuit 101 inputs the user query to at least one model-based query classifier and outputs a selection of at least one of the plurality of information resources to provide a selected information resource. By one approach, the latter activity includes selecting the at least one of the plurality of information resources as a further function of one or more language model-based binary classifiers (with a plurality of binary classifiers being useful to route the query for scenarios where there are more than two information resources). A binary classifier is a type of algorithm or model used in machine learning that categorizes data into one of two distinct classes. In the context of selecting a particular information resource, a binary classifier may, for example, assess each resource based on specific features or criteria and then classify the resource as either the suitable choice (positive class) or not suitable choice (negative class) for a given task or query. Those binary classifiers therefore effectively act as filters or decision-makers in the selection process.

By one approach, the at least one model-based query classifier comprises at least one of a large language model-based binary classifier and an autonomous agent hybrid with a plurality of differing independent large language model chains. By another approach, the at least one model-based query classifier comprises both of those options.

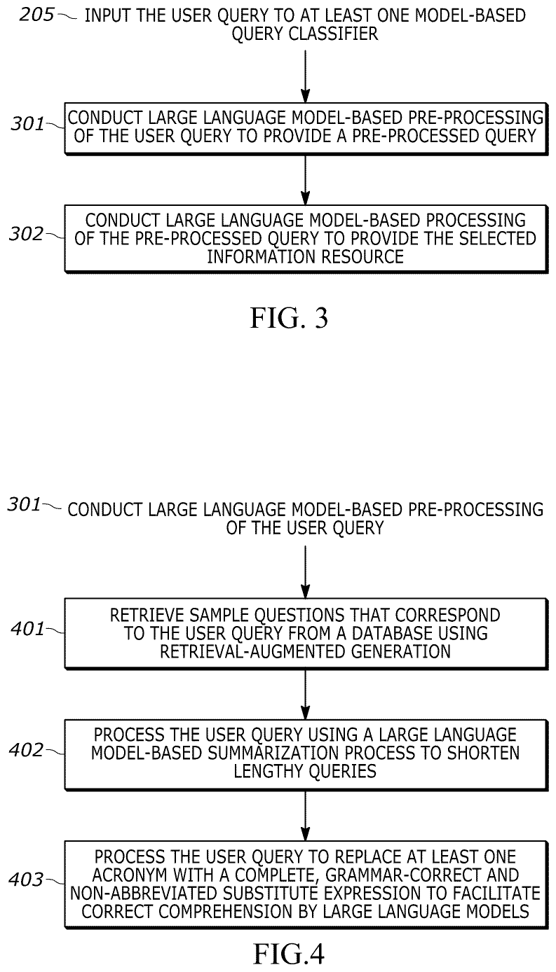

These teachings will accommodate various approaches to the foregoing activity of block 205. By one approach, and referring momentarily to FIG. 3, inputting the user query to at least one model-based query classifier can comprise, as shown at block 301, conducting large language model-based pre-processing of the user query to provide a pre-processed query and then, as shown at block 302, conducting large language model-based processing of the pre-processed query to generate the selected information resource.

By one approach, and referring now momentarily to FIG. 4, conducting the large language model-based pre-processing of the user query as referred to at block 301 of FIG. 3 can comprise at least one of (and in this illustrative example, all of) retrieving sample questions that correspond to the user query from a database using retrieval-augmented generation as shown at block 401, processing the user query using a large language model-based summarization process to shorten lengthy queries as shown at block 402, and processing the user query to replace at least one acronym with a complete, grammar-correct and non-abbreviated substitute expression to facilitate correct comprehension by large language models as shown at block 403.

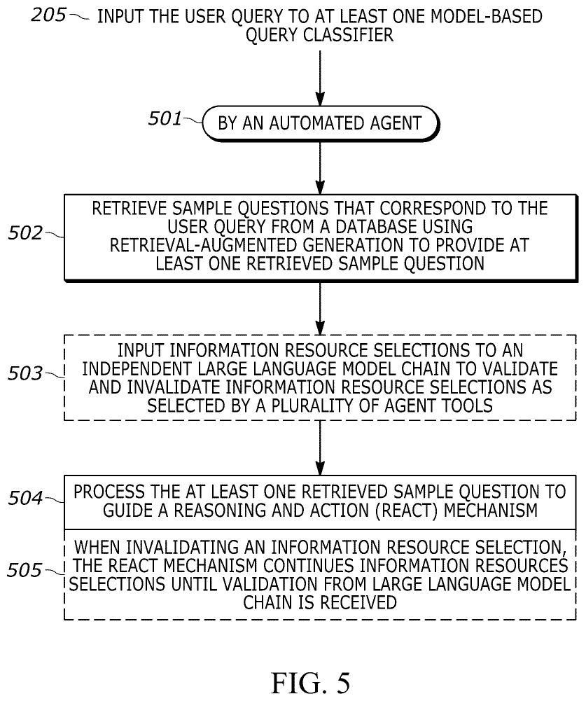

By one approach, in lieu of the foregoing or in combination therewith, and referring now momentarily to FIG. 5, the aforementioned inputting of the user query to at least one model-based query classifier can comprise using an automated agent as shown at block 501. This automated agent can then be configured to retrieve sample questions that correspond to the user query from a database using retrieval-augmented generation to provide at least one retrieved sample question as shown at block 502.

If desired, at optional block 503, the automated agent can also input information resource selections to an independent large language model chain to validate and/or invalidate information resource selections as selected by the plurality of agent tools.

At block 504, the automated agent processes the at least one retrieved sample question to guide a reasoning and action (ReAct) mechanism (and if and when an information resource selection is invalidated, the ReAct continues making information resource selections until validation from a large language model chain is received). ReAct mechanisms refer to a computational framework or model that is designed to simulate the cognitive process of reasoning followed by decision-making that leads to action. ReAct mechanisms are used in artificial intelligence systems, where an agent assesses a situation, considers potential responses based on its knowledge or learning, and then executes an action that aligns with its goals.

Referring again to FIG. 2, at block 206 the control circuit 101 assesses the user query to determine context sufficiency. By one approach, this assessment can comprise employing predetermined large language model prompts to determine the context sufficiency. When the context sufficiency is determined (at block 207) to be sufficient, this process 200 can provide (at block 208) the user query as an output query and direct the output query to the selected information resource. When, however, the context sufficiency is determined to be insufficient, at block 209 the control circuit 101 can rephrase the user query to include additional chat history (where the expression “chat history” will be understood to also include query history as well as a straight forward history of chat-based discourse) to serve as the output query and then, at block 210, direct the output query to a selected information resource corresponding to a nearest prior query on a same query sequence.

By one approach, these teachings will accommodate directing an output query to a selected information resource by directing an output query to a selected information resource as a function of both a memory gate and the query sequence to facilitate a successful query rephrasing process. In these regards, the memory gate can be configured to prevent mistakenly using a particular memory when a user switches topics while nevertheless staying in a same information resource. As an illustrative example, the gate may specify that “If you can detect clear objectives or metrics, answer ‘clear topics,’ but if you cannot detect clear objectives or metrics, answer ‘vague question.’”

Further details that comport with these teachings will now be presented. It will be understood that the specific details of these examples are intended to serve an illustrative purpose and are not intended to suggest any particular limitations with respect to these teachings.

By one approach these teachings can be embodied via a router. These teachings will inform both the router's design (including the architecture and classifier models used therein) as well as the development of tailored prompts for one or more large language models that can be integral to a memory gate and rephrasing mechanisms. The aforementioned prompts can be specifically designed to identify and enhance user queries that lack context, a common occurrence in many application settings.

For the sake of illustration, the following examples presume that the application setting is directed to supply chain operations. Those supply chain operations may pertain to commercial activities, military logistics, the operations of non-governmental agencies that provide aid to those in need, and so forth. It will be understood, however, that these teachings are not so limited. As a further presumption in these regards, these examples presume to receive supply chain inquiries from users via chatbot interfaces. Using a supply chain application setting serves a useful purpose here, in that understanding supply chain queries can be challenging due to the complexity of such queries and the limited context provided in chatbot interactions. This situation often results in suboptimal classification outcomes.

By one approach, these teachings can comprise a hybrid classification system that combines the efforts of smart agents with large language models. Traditional agent-based classification often hinges on the accuracy of tool descriptions provided by the agents, which can lead to inconsistent responses if those descriptions are imprecise. The present teachings can effectively empower agents to initiate large language model chains that can independently judge the agent's observations, thereby reinforcing the reliability of agent-based classification.

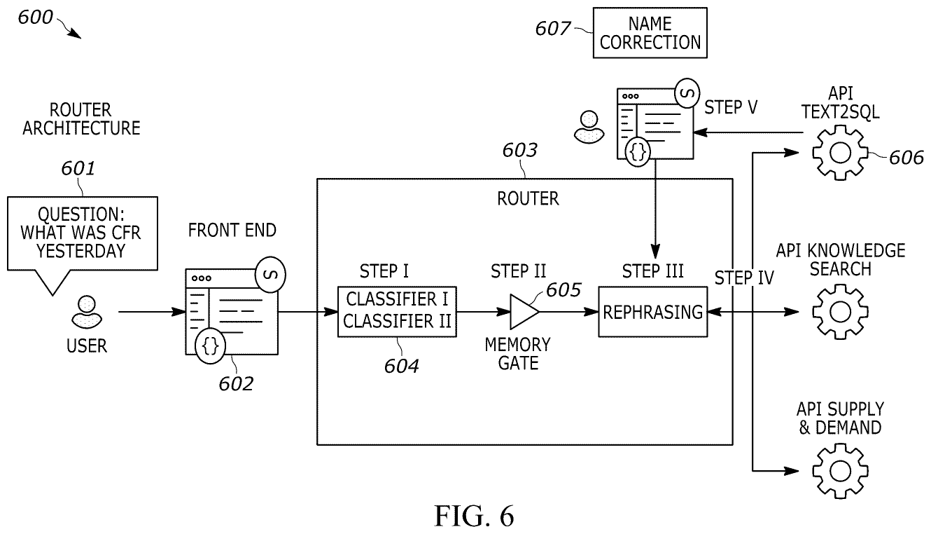

FIG. 6 presents an illustrative example of router architecture 600 that comports with the present teachings. In this approach, user questions 601 are passed through the same front end 602 and then sent to a router 603.

In the router 603, classifier models 604 are first triggered at a step I to decide which of a plurality of application APIs to assign to the question 601. (An API, or Application Programming Interface, is a set of protocols, routines, and tools for building software and applications. An API acts as an intermediary layer that allows different software systems to communicate with each other by defining a set of rules and specifications that developers can follow to access and use the functionality or data of an application, operating system, or other services.) These APIs are information resources that may contain the answer to the user's question 601 and which are, in this example, incompatible with one another in terms of accessing their respective content. In this example, the classifier models 604 have two versions. The first model is a large language model-based binary classifier and the second model is an autonomous agent hybrid with large language model chains.

At step II, users' questions 601 are input to a memory gate 605 that is configured to determine question context completeness. When lacking sufficient context, the router 603 can use historical questions from the same user to rephrase, at step Ill, the current context-poor question as a quality query in these regards. Such rephrasing of the user input can serve to provide a standalone prompt that can be used as an input prompt for a large language model tool to generate, for example, text to SQL. This rephrasing mechanism can be configured, when a user input contains an acronym and the chat history has the meaning of that acronym, to include both the acronym and the meaning in the output.

At step IV, quality questions can be be sent to the API that has been determined at step I. When a Text-to-SQL API 606 is included, in this example a name-correction mechanism can be included as a step V to ensure that key information (such as product and category names) in user questions are identical to the schema definitions that are observed in the corresponding supply chain database.

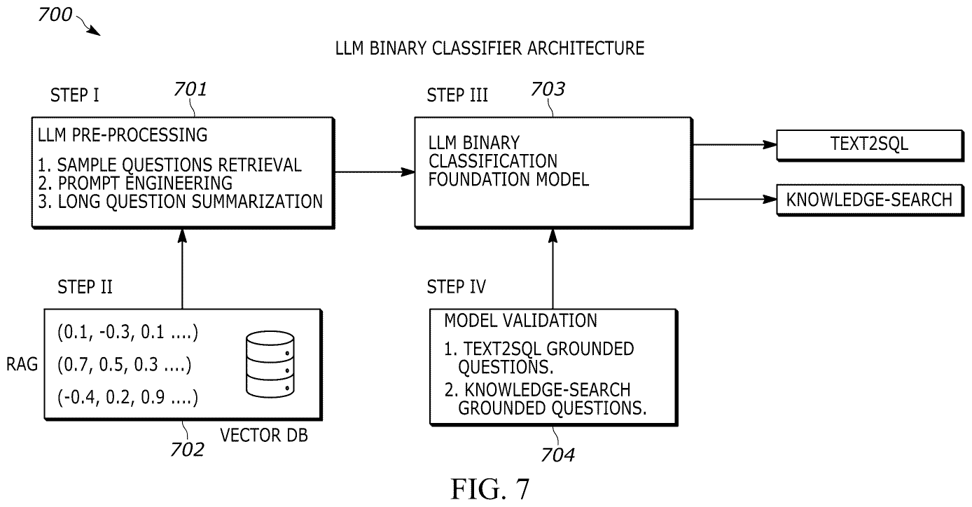

FIG. 7 presents an illustrative large language model binary classifier architecture 700 that comports with these teachings. In particular, this binary classifier can serve as Classifier I as described above with reference to FIG. 6.

At step I, a large language model pre-processing stage 701, the binary classifier first retrieves sample questions (based on user questions) from a vector database 702 using a generative artificial intelligence technique known as retrieval augmented generation (RAG). For long and detailed questions, a large language model-based summarization process can be implemented to reduce the long question into a more concise question. Such summarization process can benefit the accuracy of the following classification activity.

A large language model binary classification foundation model 703 effects binary classification using commercial foundation models such as from the OpenAl GPT series. Analogous to traditional models, a model validation mechanism 704 can use grounded questions to facilitate determining overall classifier accuracy.

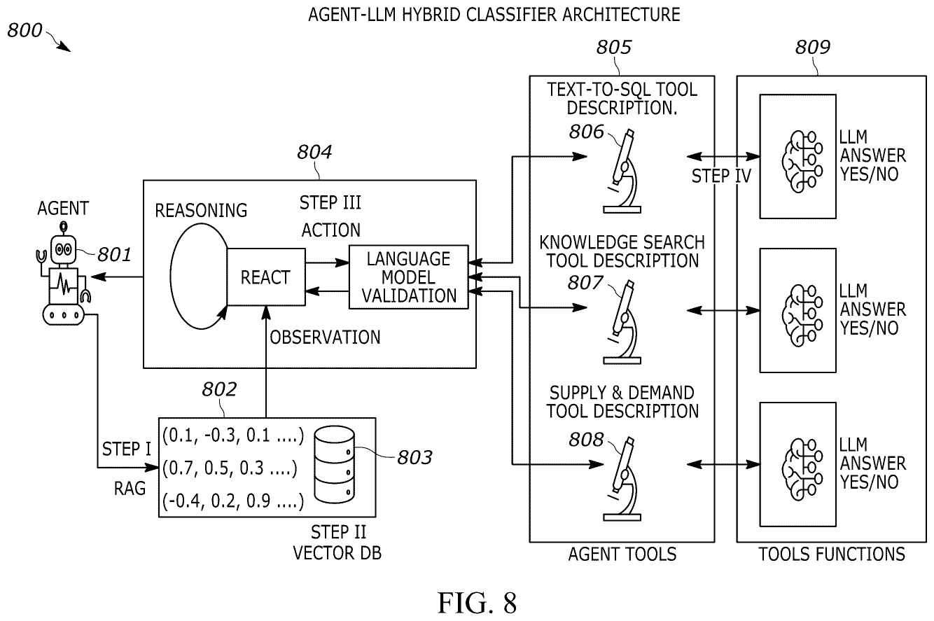

FIG. 8 presents an illustrative agent-large language model hybrid classifier architecture 800 that comports with these teachings. In particular, this binary classifier can serve as Classifier II as described above with reference to FIG. 6.

The illustrated classification model comprises an agent and large language model hybrid cognitive decision process. When a question passes to an agent 801, the agent 801 can automatically apply retrieval augmented generation (RAG) at block 802 and sampling questions from a vector database 803. The sample questions can be considered in the agent cognitive process for agent decision making.

The cognitive process is configured as a ReAct (Reasoning and Action) mechanism 804 that can implement any of a plurality of different agent tools 805. Each tool 805 in this illustrative example contains a tool description and tool function. In this example, a first tool 806 has a text-to-SQL function, a second tool 807 has a knowledge search function, and a third tool 808 has a supply and demand function. The tool description and function are used by the agent 801 to decide whether the question belongs to a specific application interface as described above with reference to FIG. 6.

The tool functions can comprise a large language model chain 809 that can help the agent 801 to confirm its decision. This approach, which can combine a ReAct agent, a large language model chain, and RAG, can successfully mitigate large language model hallucinations and yield excellent classification accuracy and consistency.

By one approach, these teachings can serve to pinpoint questions that lack context and selectively infuse those questions with the most pertinent memories from relevant topics. This strategy can markedly enhanced the quality of queries, leading to a significant boost in classification precision.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

1. A method to process and direct a query to an information resource selected from amongst a plurality of information resources, the method comprising:
by a control circuit:
receiving a user query;
inputting the user query to at least one model-based query classifier and outputting a selection of at least one of the plurality of information resources to provide a selected information resource;
assessing the user query to determine context sufficiency;
when the context sufficiency is determined to be sufficient, providing the user query as an output query and directing the output query to the selected information resource;
when the context sufficiency is determined to be insufficient, rephrasing the user query to include additional chat history to serve as the output query; and
directing the output query to a selected information resource corresponding to a nearest prior query on a same query sequence.

2. The method of claim 1 wherein the at least one model-based query classifier comprises at least one of:
a large language model-based binary classifier; and
an autonomous agent hybrid with a plurality of differing independent large language model chains.

3. The method of claim 2 wherein the at least one model-based query classifier comprises both of:
a large language model-based binary classifier; and
an autonomous agent hybrid with a plurality of differing independent large language model chains.

4. The method of claim 1 wherein inputting the user query to at least one model-based query classifier comprises:
conducting large language model-based pre-processing of the user query to provide a pre-processed query;
conducting large language model-based processing of the pre-processed query to provide the selected information resource.

5. The method of claim 4 wherein conducting the large language model-based pre-processing of the user query comprises at least one of:
retrieving sample questions that correspond to the user query from a database using retrieval-augmented generation;
processing the user query using a large language model-based summarization process to shorten lengthy queries; and
processing the user query to replace at least one acronym with a complete, grammar-correct and non-abbreviated substitute expression to facilitate correct comprehension by large language models.

6. The method of claim 1 wherein the at least one model-based query classifier comprises a large language model-based binary classifier.

7. The method of claim 1 wherein inputting the user query to at least one model-based query classifier comprises:
by an automated agent:
retrieving sample questions that correspond to the user query from a database using retrieval-augmented generation to provide at least one retrieved sample question;
processing the at least one retrieved sample question to guide a reasoning and action (ReAct) mechanism.

8. The method of claim 7 further comprising:
by the automated agent:
inputting information resource selections to an independent large language model chain to validate and invalidate information resource selections as selected by the plurality of agent tools;
when invalidating an information resource selection, the ReAct continues information resources selections until validation from large language model chain is received.

9. The method of claim 1 wherein assessing the user query to determine context sufficiency comprises employing predetermined large language model prompts to determine the context sufficiency.

10. The method of claim 1 wherein directing an output query to a selected information resource further comprises directing an output query to a selected information resource as a function of a memory gate and the query sequence to facilitate a successful query rephrasing process.

11. The method of claim 10 wherein use of the memory gate is configured to prevent mistakenly using memory when a user switches topics while nevertheless staying in a same information resource.

12. The method of claim 1 further comprising:
assessing the user query to check taxonomy absence for product/category related query contents;
when taxonomy absence is detected, provide real-time recommendations on correct taxonomy to the user to prove;
when taxonomy is proved, rephrasing the user query to include proved taxonomy.

13. The method of claim 1 wherein inputting the user query to at least one model-based query classifier and outputting a selection of at least one of the plurality of information resources to provide a selected information resource further comprises selecting the at least one of the plurality of information resources as a further function of a plurality of binary classifiers.

14. An apparatus to process and direct a query to an information resource selected from amongst a plurality of information resources, the apparatus comprising:
a control circuit configured to:
receive a user query;
input the user query to at least one model-based query classifier and output a selection of at least one of the plurality of information resources to provide a selected information resource;
assess the user query to determine context sufficiency;
when the context sufficiency is determined to be sufficient, provide the user query as an output query and direct the output query to the selected information resource;
when the context sufficiency is determined to be insufficient, rephrase the user query to include additional chat history to serve as the output query; and
direct the output query to a selected information resource corresponding to a nearest prior query on a same query sequence.

15. The apparatus of claim 14 wherein the at least one model-based query classifier comprises at least one of:
a large language model-based binary classifier; and
an autonomous agent hybrid with a plurality of differing independent large language model chains.

16. The apparatus of claim 15 wherein the at least one model-based query classifier comprises both of:
a large language model-based binary classifier; and
an autonomous agent hybrid with a plurality of differing independent large language model chains.

17. The apparatus of claim 14 wherein the control circuit is configured to input the user query to at least one model-based query classifier by:
conducting large language model-based pre-processing of the user query to provide a pre-processed query;
conducting large language model-based processing of the pre-processed query to provide the selected information resource.

18. The apparatus of claim 17 wherein the control circuit is configured to conduct the large language model-based pre-processing of the user query by at least one of:
retrieving sample questions that correspond to the user query from a database using retrieval-augmented generation;
processing the user query using a large language model-based summarization process to shorten lengthy queries; and
processing the user query to replace at least one acronym with a complete, grammar-correct and non-abbreviated substitute expression to facilitate correct comprehension by large language models.

19. The apparatus of claim 14 wherein the at least one model-based query classifier comprises a large language model-based binary classifier.

20. The apparatus of claim 14 wherein inputting the user query to at least one model-based query classifier comprises:
by an automated agent:
retrieving sample questions that correspond to the user query from a database using retrieval-augmented generation to provide at least one retrieved sample question;
processing the at least one retrieved sample question to guide a reasoning and action (ReAct) mechanism.
